(19) United States
(12) Patent Application Publication
(10) Pub. No.: US 2004/0037013 A1
(43) Pub. Date: Feb. 26, 2004

(54) Magneto-resistance effect type head

(75) Inventor: Takashi Suda, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/455,807

(22) Filed: Jun. 6, 2003

(30) Foreign Application Priority Data
Jun. 6, 2002 (JP) 2002-165673

(51) Int. Cl. G11B 5/39

(52) U.S. Cl. 360/320; 29/603.14

(57) ABSTRACT

A magneto-resistance effect type head (MR head) is formed of a laminated structure by using a thin film forming technique. In the magneto-resistance effect type head, an insulating layer, a lower shield layer, a lower gap layer, a magnetic resistance effect layer, an upper gap layer, an upper shield layer, and a protective layer are layered in sequence on one end face of a base plate. The reaction preventive layer made of an insulating material is formed between the base plate and the insulating layer.

### FIELD OF THE INVENTION

The present invention relates to a magneto-resistance effect type head, more particularly to a magneto-resistance effect type head having an improved electromagnetic conversion characteristic in data-reproducing process of a magnetic tape.

### BACKGROUND OF THE INVENTION

Conventionally, a magnetic tape, which is a magnetic recording medium, had been-widely used as a signal-recording tape for recording and/or reproducing data of signals. Recently, a proposal for a narrower track, which reduces a track width of the magnetic tape more, has been considered as a countermeasure to increase a recording density per unit area. To realize this proposal, “a narrower gap”, which reduces a magnetic gap more, has been required in a magnetic head which is used in magnetic recording/reproducing devices. Accordingly, a magneto-resistance effect type head capable of having the narrower gap by using a thin film forming technique has been widely used.

FIG. 1 is a cross sectional view showing the main part of the conventional magneto-resistance effect type head. As shown in FIG. 1, a conventional magneto-resistance effect type head 30 is consisted of a laminated structure by using the thin film forming technique. The laminated structure is constituted in following ways. An insulating layer 32, a lower shield layer 33, a lower gap layer 34, a magneto-resistance effect layer 35, an upper gap layer 36, an upper shield layer 37, and a protective layer 38 are layered in sequence on a base plate 31. Herein, the base plate 31 is made of a nonmagnetic material. The insulating layer 32 is made of an insulating material. The lower shield layer 33 is made of a magnetic material. The lower gap layer 34 is made of the nonmagnetic material. The upper gap layer 36 is made of the nonmagnetic material. The upper shield layer 37 is made of a magnetic material. The protective layer 38 is made of the insulating material. Then, a portion sandwiched between the lower shield layer 33 and the upper shield layer 37 corresponds to a magnetic gap G as a reading portion of the magneto-resistance effect type head 30. Alumina titanium carbide (AlTiC:Al₂O₃.TiC) as the nonmagnetic material is commonly used for the base plate 31. Alumina (Al₂O₃) or silica (SiO₂) is used for the insulating layer 32.

However, a following drawback has been arisen when AlTiC is used for the base plate 31 of the conventional magneto-resistance effect type head 30 shown in FIG. 1. In data-reproducing process, when the magnetic tape slides on the magneto-resistance effect type head 30, a pressure is applied to the sliding face of the magnetic tape on the base plate 31. This has been brought about a phenomenon that particles of AlTic as component martial of the base plate 31 are come off from the surface of the base plate 31.,

The reason why this phenomenon has been brought about can be attributed to a following assumption as one factor. In a manufacturing process of the magneto-resistance effect type head 30, when the insulating layer 32 is formed as a base film on the base plate 31, an impact occurs on the base plate 31. Thereby, oxygen atoms (0) contained in the insulating layer 32 are penetrated into the base plate 31 to bond with Aluminum (Al) or Titanium (Ti) contained in the base plate 31 so that Aluminum oxide or Titanium oxide is provided. Consequently, Aluminum, Titanium, and Carbon as component element of the base plate 31 can not be bonded together due to this oxide.

When particles of AlTic are come off from the surface of the base plate 31, the surface becomes rough so that the magnetic tape can not slide smoothly thereon. Thereby, friction force between the magnetic tape and the magneto-resistance effect type head 30 is increased in data-reproducing process of the magnetic tape. This causes a sliding ability of the magnetic tape to be deteriorated. Accordingly, the magneto-resistance effect type head 30 can not read signals accurately from the magnetic tape.

Alumina and silica as component elements of the insulating layer 32 are softer than AlTiC as component element of the base plate 31. When particles of AlTiC are come off from the surface of the base plate 31, these particles play a roll of an abrasive to wear the sliding face of the magnetic tape on each layers of the insulating layer 32 through the protective layer 38. Thereby, the magnetic tape can not perfectly be contacted to the magnetic resistance effect type head 30 in data-reproducing process of the magnetic tape. As a result, the magneto-resistance effect type head 30 can not read signals accurately from the magnetic tape. Accordingly, an object of the present invention is to provide the magneto-resistance effect type head such that particles as component material of the base plate are not come off from the surface of the base plate even though the pressure is applied to the sliding face of the magnetic tape on the base plate of the magneto-resistance effect type head in data-reproducing process of the magnetic tape.

### SUMMARY OF THE INVENTION

The magneto-resistance effect type head of the present invention comprises a base plate made of a nonmagnetic material, a reaction preventive layer made of an insulating material and formed on one end face of the base plate, an insulating layer made of an insulating material and layered on the reaction preventive layer, a lower shield layer made of a magnetic material and layered on the insulating layer, a lower gap layer made of a nonmagnetic material and layered on the lower shield layer, a magneto-resistance effect layer layered on the lower gap layer, an upper gap layer made of a nonmagnetic material and layered on the magneto-resistance effect layer, an upper shield layer made of a magnetic material and layered on the upper gap layer, and a protective layer made of an insulating material and layered on the upper shield layer, wherein the reaction preventive layer made of the insulating material is formed between said base plate and said insulating layer.

According to the present invention, the reaction preventive layer made of the insulating material is formed between the base plate and the insulating layer. Thereby, oxygen atoms (o) contained in the insulating layer can not be penetrated into the base plate due to the existence of the reaction preventive layer when the insulating layer is formed as the base layer on the base plate in the manufacturing process of the magneto-resistance effect type head. Accordingly, bonds of each atom of component materiel of the base plate can be maintained so that particles as component material of the base plate are not come off from the surface of the base plate even though the pressure is applied to the sliding face of the magnetic tape on the base plate in data-reproducing process.

The reaction preventive layer can be constituted of Alumina (Al₂O₃) or Titanium oxide (TiO₂). However, when the base plate is constituted of Alumna titanium carbide (AlTiC:Al₂O₃.TiC), it is preferable that the reaction preventive layer is constituted of Alumna (Al₂O₃)

Next, the magneto-resistance effect type head with regard to the present invention is manufactured in following ways. A layer made of the insulating material is formed on one end face of the base plate made of the nonmagnetic material. Then, the layer is left in a present state for a predetermined time until a temperature of the layer is lowered. After the layer is stabilized to become the reaction preventive layer during this predetermined time, the insulating layer made of the insulating material is formed as a base layer on said reaction preventive layer. After that, the lower shield layer, the lower gap layer, the magneto-resistance effect layer, the upper gap layer, the upper shield layer, and the protective layer are layered in sequence on said insulating layer. Herein, the lower shield layer is made of the magnetic material. The lower gap layer is made of the nonmagnetic material. The upper gap layer is made of the nonmagnetic material. The upper shield layer is made of the magnetic material. The protective layer is made of the insulating material.

According to the manufacturing method of the magneto-resistance effect type head with regard to the present invention, a layer made of the insulating material is formed on one end face of the base plate made of the nonmagnetic material. Then, the layer is left in a present state for a predetermined time until the temperature of the layer is lowered. After the layer is stabilized to become the reaction preventive layer during this predetermined time, the insulating layer made of the insulating material is formed as the base layer on said reaction preventive layer. Thereby, when the insulating layer is formed, oxygen atoms contained in the insulating layer can not be penetrated into the base plate due to the existence of the reaction preventive layer even though the impact occurred on the sliding face of the base plate.

Accordingly, bonds of each atom of component materiel of the base plate can be maintained so that particles as component material of the base plate are not come off from the surface of the base plate even though the pressure is applied to the sliding face of the magnetic tape on the base plate in data-reproducing process of the magnetic tape

### BRIEF DESCRIPTION OF THE DRAWINGS

FIG. 1 is a cross sectional view showing the main part of the conventional magneto-resistance effect type head.

FIG. 2 is a cross sectional view showing the main part of the magneto-resistance effect type head of the present invention.

FIG. 3 is a perspective view of the magneto-resistance effect type head shown in FIG. 2.

FIG. 4A is a cross sectional view to explain a manufacturing method of the magneto-resistance effect type head shown in FIG. 2 by indicating a state that a reaction preventive layer is formed on one end face of the base plate.

FIG. 4B is a cross sectional view followed by FIG. 4A to indicate a state that the insulating layer is formed on the reaction preventive layer.

FIG. 4C is a cross sectional view followed by FIG. 4B to indicate a state that the lower shield layer and the lower gap layer are formed on the insulating layer.

FIG. 5A is a cross sectional view followed by FIG. 4C to indicate a state that the magneto-resistance effect layer and the upper gap layer are formed on the lower gap layer.

FIG. 5B is a cross sectional view followed by FIG. 5A to indicate a state that the upper shield layer is formed on the upper gap layer.

FIG. 5C is a cross sectional view followed by FIG. 5B to indicate a state that the protective layer is formed on the upper shield layer.

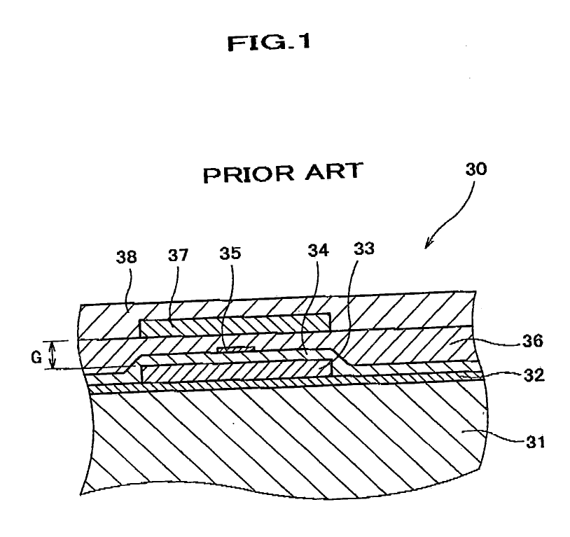

### DETAILED EXPLANATION OF THE PREFERRED EMBODIMENTS OF THE INVENTION

The embodiment of the present invention will be now properly described with reference to the accompanied drawings. The embodiment is assumed that alumina titanium carbide (AlTiC:Al₂O₃.TiC) is used for a base plate of a magneto-resistance effect type head. A structure of the magneto-resistance effect type head with regard to the present invention will be described.

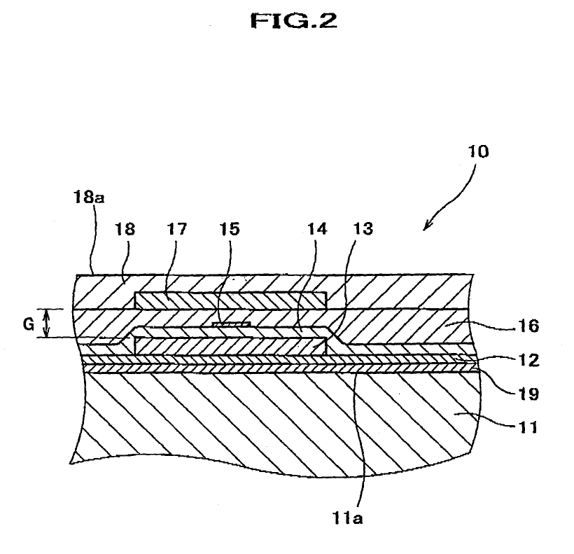

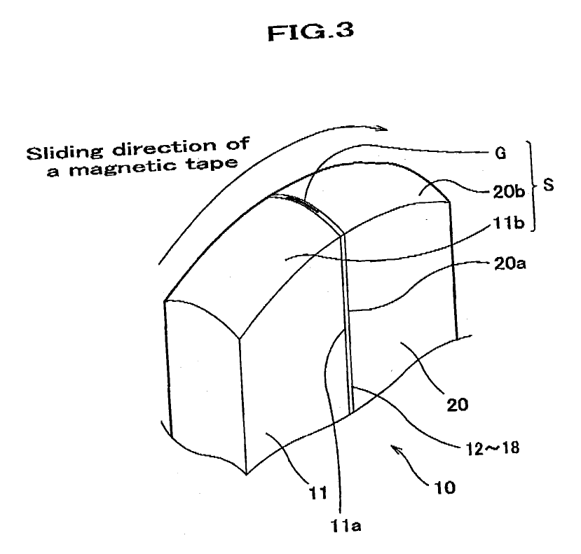

FIG. 2 is a cross sectional view showing the main part of the magneto-resistance effect type head with regard to the present invention. FIG. 3 is a perspective view of the magneto-resistance effect type head shown in FIG. 2. Herein, a thickness of every layer shown in FIG. 2 is drawn with an enlargement for better understanding. As shown in FIG. 2, the magneto-resistance effect type head (hereinafter referred to as “MR head”) is consisted of a laminated structure by using a thin film forming technique.

Now, aforementioned laminated structure is constituted in following ways. A reaction preventive layer 19 is formed on one end face 11a of a base plate 11. An insulating layer 12 is formed as a base film on the reaction preventive layer 19. Then, a lower shield layer 13, a lower gap layer 14, a magneto-resistance effect layer 15, an upper gap layer 16, an upper shield layer 17, and a protective layer 18 are layered in sequence on the insulating layer 12. Herein, a portion sandwiched between the lower shield layer 13 and the upper shield layer 17 corresponds to a magnetic gap G as a reading portion of the MR head 10.

A protective plate 20 (shown in FIG. 3) is connected to one end face 18a (shown in FIG. 2) of the protective layer 18. As shown in FIG. 2 and FIG. 3, the reaction preventive layer 19, the insulating layer 12, the lower shield layer 13, the lower gap layer 14, the magneto-resistance effect layer 15, the upper gap layer 16, the upper shield layer 17, and the protective layer 18 are sandwiched between the one end face 20a of the protective plate 20 and the one end face 11a of the base plate 11.

As shown in FIG. 3, a top face 11b, which is one end face of the base plate 11, and a top face 20b, which is one end face of the protective plate 20, are formed into a curved face. The top face 11b and the top face 20b are a part of a sliding face S of the magnetic tape, wherein the magnetic tape slides on the MR head 10 in data-reproducing process of the magnetic tape. The sliding face S is formed into a surface of a gentle arc along the sliding direction of the magnetic tape.

Said magnetic gap G as a reading portion of the MR head is exposed to the sliding face S of the magnetic tape. When the magnetic tape passed over the magnetic gap G, the magnetic gap G reads signals recorded as a magnetic field on the magnetic tape. Now, the magnetic gap G reads said signals by the magneto-resistance effect layer 15.

When data are reproduced from the magnetic tape, a sense current as a steady-state current is flown in the magneto-resistance effect layer 15. The magnetic gap G reads signals recorded on the magnetic tape by detecting a resistance change in the magneto-resistance effect layer 15 as an amount of voltage change. The base plate 11 is formed of AlTiC (Al₂O₃.TiC) as the nonmagnetic material. One end face 11a of the base plate 11 is approximately a rectangular shape. The reaction preventive layer 19, the insulating layer 12′, the lower shield layer 13, the lower gap layer 14, the magneto-resistance effect layer 15, the upper gap layer 16, the upper shield layer 17, and the protective layer 18 are layered in sequence on one end face 11a by using a thin film forming technique.

As shown in FIG. 3, a top face 11b of the base plate 11 is a part of the sliding face S of the magnetic tape together with a top face 20b of the protective plate 20.

The reaction preventive layer 19 is consisted of alumina (Al₂O₃) or Titanium oxide (TiO₂) as the insulating material. The reaction preventive layer 19 is formed on the one end face 11a of the base plate 11 so that oxygen atoms contained in the insulating layer 12 can not be penetrated into the base plate 11 when the insulating layer 12 is formed. The reaction preventive layer 19 is formed as a layer having a thickness in the range of 50 to 100 Å. The insulating layer 12 is formed of alumina (Al₂O₃) or silica (SiO₂) as the insulating material. The insulating layer 12 is the base film having a thickness in the range of 15 to 30 μm. The lower shield layer 13 and the upper shield layer 17 are formed of a polycrystalline ferrite such as Fe—Si—Al alloy (Sendust) Ni—Fe alloy (Permalloy), and Ni—Zn alloy (Hematolite) as the magnetic material. The lower gap layer 14 and the upper gap layer 16 are formed of alumina (Al₂O₃) as the nonmagnetic material as one example. The magneto-resistance effect layer 15 is consisted of a laminated structure wherein a non-magnetic layer (SHUNT layer) is layered on a soft magnetic layer (SAL layer), and a magneto-resistance effect layer (MR layer) is layered on the non-magnetic layer (SHUNT layer) as one example. Herein, the soft magnetic layer (SAL layer) is formed of Ni—Fe—Nb alloy. The non-magnetism layer (SHUNT layer) is formed of tantalum (Ta). And the magneto-resistance effect layer (MR layer) is formed of Ni—Fe alloy (Permalloy). The magneto-resistance effect layer 15 is a part of the magnetic gap G together with the lower gap layer 14 and the upper gap layer 16. The protective layer 18 is formed of alumina (Al₂O₃), silica (SiO₂), or the like in the same way as said insulating layer 12 is.

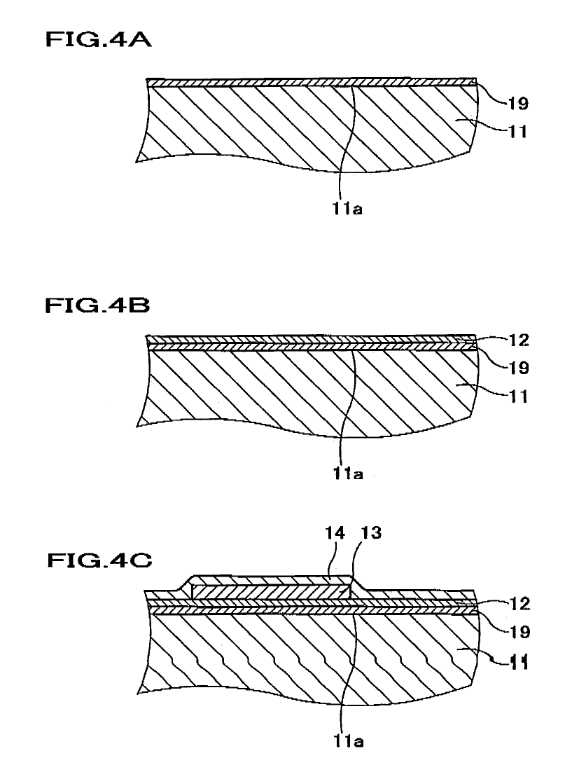

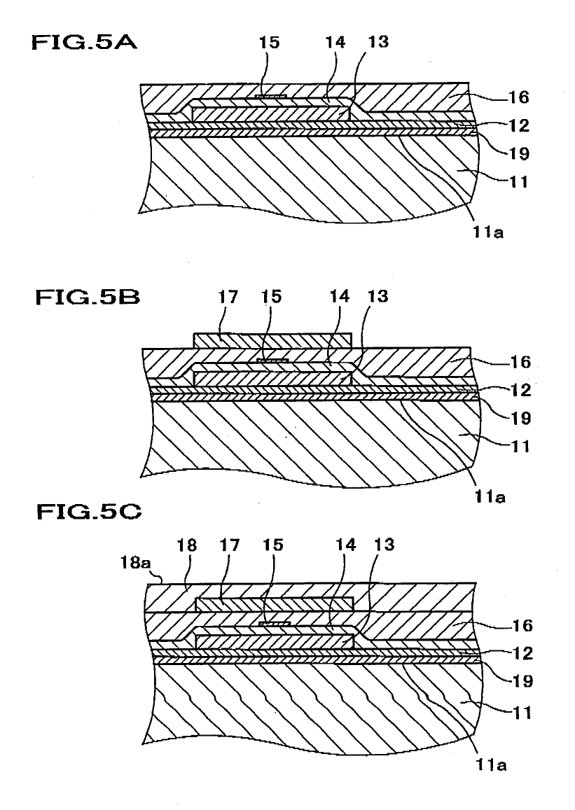

Next, descriptions will be made to explain the manufacturing method of aforementioned MR head of the present invention with reference to FIGS. 4A, 4B, 4C, 5A, 5B, and 5C. FIGS. 4A through 5C are cross sectional views to explain the manufacturing method of MR head 10.

As shown in FIG. 4A, the reaction preventive film 19 is formed on one end face 1a of the base plate 11 by means of a sputtering. The reaction preventive film 19 is formed as a thin film having a thickness in the range of 50 to 100 Å. Next, as shown in FIG. 4B, the insulating layer 12 is formed as a layer having a thickness in the range of 15 to 30 μm on the reaction preventive layer 19 by means of the sputtering. However, the insulating layer 12 is not formed until a film of the reaction preventive layer 19 is stabilized when a temperature of the reaction preventive layer 19 is lowered after a predetermined time has passed since the reaction preventive layer 19 is-formed. At this time, the reaction preventive layer 19 is already formed on one end face 11a of the base plate 11. Thereby, when the insulating layer 12 is formed, oxygen atoms contained in the insulating layer 12 can not be penetrated into the base plate 11 due to the existence of the reaction preventive layer 19 even though the impact occurred. Next, as shown in FIG. 4C, the lower shield layer 13 is formed on the insulating layer 12 by means of a metal plating. Then, the lower gap layer 14 is formed on the lower shield layer 13 by means of the sputtering.

Next, as shown in FIG. 5A, the magneto-resistance effect layer 15 and the upper gap layer 16 are formed on the lower gap layer 14 in sequence by means of the sputtering. Then, as shown in FIG. 5B, the upper shield layer 17 is formed on the upper gap layer 16 by means of the metal plating. Finally, as shown in FIG. 5C, the protective layer 18 is formed on the upper shield layer 17 by means of the sputtering. Then, as shown in FIG. 2 and FIG. 3, the protective plate 20 is connected to one end face 18a of the protective layer 18. As finishing process, the top face 11b of the base plate 11 and the top face 20b of the protective plate 20 are ground so that the sliding face S of the magnetic tape is formed into a surface of a gentle arc. As described above, according to the MR head 10 of the present invention, the reaction preventive layer 19 made of the insulating material is formed between the base plate 11 and the insulating layer 12. When the insulating layer 12 is formed as the base layer on the base plate 11 in the manufacturing process of the magneto-resistance effect type head 10, oxygen atoms contained in the insulating layer 12 can not be penetrated into the base plate 11 due to the existence of the reaction preventive layer 19.

Accordingly, bonds of each atom (Aluminum, Titanium, and Carbon in this case) of component materiel of the base plate 11 can be maintained so that particles (AlTiC in this case) as component material of the base plate 11 are not come off from the surface of the base plate 11 even though the pressure is applied to the sliding face of the magnetic tape on the base plate 11 in data-reproducing process of the magnetic tape

What is claimed is:

1. A magneto-resistance effect type head, comprising:
a base plate made of a nonmagnetic material;
a reaction preventive layer made of an insulating material and formed on one end face of the base plate;
an insulating layer made of an insulating material and layered on the reaction preventive layer;
a lower shield layer made of a magnetic material and layered on the insulating layer;
a lower gap layer made of a nonmagnetic material and layered on the lower shield layer;
a magneto-resistance effect layer layered on the lower gap layer;
an upper gap layer made of a nonmagnetic material and layered on the magneto-resistance effect layer;
an upper shield layer made of a magnetic material and layered on the upper gap layer; and
a protective layer made of an insulating material and layered on the upper shield layer,
wherein the reaction preventive layer made of the insulating material is formed between said base plate and said insulating layer.

2. The magneto-resistance effect type head according to claim 1, wherein said base plate is made of Alumna titanium carbide (Al₂O₃.TiC).

3. The magneto-resistance effect type head according to claim 1, wherein said reaction preventive layer is made of Alumina (Al₂O₃) or Titanium oxide (TiO₂).

4. The magneto-resistance effect type head according to claim 2, wherein said reaction preventive layer is made of Alumina (Al₂O₃).

5. The magneto-resistance effect type head according to claim 3, wherein said reaction preventive layer has a thickness in the range of 50 to 100 Å.

6. The magneto-resistance effect type head according to claim 4, wherein said reaction preventive layer has a thickness in the range of 50 to 100 Å.

7. A manufacturing method of the magneto-resistance effect type head, said method comprising the steps of;
depositing a layer made of an insulating material on one end face of a base plate,
forming a reaction preventive layer by leaving said layer to be stabilized during a predetermined time,
forming an insulating layer made of an insulating material on the reaction preventive layer,
layering a lower shield layer made of a magnetic material on the insulating layer,
layering a lower gap layer made of a nonmagnetic material on the lower shield layer,
layering a magneto-resistance effect layer on the lower gap layer,
layering an upper gap layer made of a nonmagnetic material on the magneto-resistance effect layer,
layering an upper shield layer made of a magnetic material on the upper gap layer, and
layering a protective layer made of an insulating material on the upper shield layer.

8. The manufacturing method of the magneto-resistance effect type head according to claim 7, further comprising a step wherein a protective plate is connected to said protective layer.

9. The manufacturing method of the magneto-resistance effect type head according to claim 7, wherein said base plate is made of Alumna titanium carbide (Al₂O₃.TiC).

10. The manufacturing method of the magneto-resistance effect type head according to claim 7, wherein said reaction preventive layer in made of Alumina (Al₂O₃) or Titanium oxide (TiO₂).

11. The manufacturing method of the magneto-resistance effect type head according claim 9, wherein said reaction preventive layer is made of Alumina (Al₂O₃).

12. The manufacturing method of the magneto-resistance effect type head according to claim 7, wherein said reaction preventive layer is formed by means of a sputtering.

13. The manufacturing method of the magneto-resistance effect type head according to claim 7, wherein said reaction preventive layer is formed as a layer having a thickness in the range of 50 to 100 Å.

14. The manufacturing method of the magneto-resistance effect type head according to claim 10, wherein said reaction preventive layer is formed as a layer having a thickness in the range of 50 to 100 Å.

15. The manufacturing method of the magneto-resistance effect type head according to claim 11, wherein said reaction preventive layer is formed as a layer having a thickness in the range of 50 to 100 Å.
